(19) United States
(12) Patent Application Publication
(10) Pub. No.: US 2015/0158426 A1
(43) Pub. Date: Jun. 11, 2015

(54) APPARATUS, CONTROL METHOD THEREOF AND COMPUTER-READABLE STORAGE MEDIUM

(71) Applicant: CANON KABUSHIKI KAISHA, Tokyo (JP)

(72) Inventor: Tetsuri Sonoda, Yokohama-shi (JP)

(21) Appl. No.: 14/523,015

(22) Filed: Oct. 24, 2014

(30) Foreign Application Priority Data
Dec. 9, 2013 (JP) 2013-254495

(51) Int. Cl. B60Q 9/00; B60Q 1/00; B60Q 5/00; B60Q 1/52

(52) U.S. Cl. CPC B60Q 9/008; B60Q 1/525; B60Q 1/0023; B60Q 5/006

(57) ABSTRACT

An apparatus for informing a target person of information, includes a detection unit adapted to detect a limited appearance of the target person based on a state of usage of another apparatus of the target person, a selection unit adapted to select a notifying unit for notifying the target person of information through an unlimited appearance of the target person based on the detection result of the detection unit, and a control unit adapted to control to notify the target person of information by the notifying unit selected by the selection unit.

### BACKGROUND OF THE INVENTION

1. Field of the Invention

The present invention relates to an apparatus and control method thereof, and a computer-readable storage medium and, more particularly, to an information transmission technique for appropriately performing information notification to a target person.

2. Description of the Related Art

An information transmission apparatus for appropriately performing information notification to a target person is used in a traffic safety system or the like for achieving traffic safety between automobiles and pedestrians on roads. For example, Japanese Patent Laid-Open No. 7-306995 discloses a system in which a pedestrian carries a transmitter and a receiver is mounted in an automobile. When this receiver senses that a radio wave from the transmitter carried by the pedestrian falls within an in-of-service, the receiver measures a distance to the transmitter or its position. If the receiver determines the danger of a collision, a warning is output to the pedestrian and the driver in the automobile, thereby avoiding the danger.

However, in the conventional system described above, the warning is output by a fixed method regardless of the situations of the target persons. This makes it impossible to achieve a sufficient effect for avoiding the danger. For example, in an arrangement for outputting an auditory warning from the receiver, the auditory perception of the pedestrian may be limited by an earphone, for example, when the pedestrian is listening to music via the earphone. This often makes it impossible to perform appropriate warning.

### SUMMARY OF THE INVENTION

The present invention has been made in consideration of the above problem and provides a technique for appropriately and reliably transmitting information even if the appearance of a target person is limited.

According to one aspect of the present invention, an apparatus for informing a target person of information, includes: a detection unit adapted to detect a limited appearance of the target person based on a state of usage of another apparatus of the target person; a selection unit adapted to select a notifying unit for notifying the target person of information through an unlimited appearance of the target person based on the detection result of the detection unit; and a control unit adapted to control to notify the target person of information by the notifying unit selected by the selection unit.

According to another aspect of the present invention, a method of controlling an apparatus for notifying a target person of information, includes: a detection step of causing a detection unit to detect a limited appearance of the target person based on a state of usage of another apparatus of the target person; a selection step of causing a selection unit to select a notifying unit for notifying the target person of information through an unlimited appearance based on the detection result of the detection step; and a control step of causing a control unit to control to notify the target person of information by the notifying unit selected in the selection step.

Further features of the present invention will become apparent from the following description of exemplary embodiments (with reference to the attached drawings).

### BRIEF DESCRIPTION OF THE DRAWINGS

FIG. 1 is a view showing an example of the arrangement of an information transmission system;

FIG. 2 is a view showing an example of the arrangement of an information terminal;

FIG. 3 is a flowchart showing the processing sequence of information transmission processing;

FIG. 4 is a view showing a state in which a vehicle and the information terminal are observed from the above vertically;

FIG. 5 is a flowchart showing the processing sequence of state-of-usage detection processing;

FIG. 6 is a flowchart showing the processing sequence of notifying unit selection processing;

FIG. 7 is a flowchart showing the processing sequence of the notifying unit selection processing;

FIG. 8 is a table showing the correspondence relationship between the states of usage of the information terminals and usable notifying units;

FIG. 9 is a view showing an example of the arrangement of an information transmission system;

FIG. 10 is a flowchart showing the processing sequence of information transmission processing;

FIG. 11 is a view showing a state in which a vehicle and a target person are observed from the above vertically; and

FIG. 12 is a flowchart showing the processing sequence of limited state detection processing.

### DESCRIPTION OF THE EMBODIMENTS

Embodiments of the present invention will be described in detail with reference to the accompanying drawings.

A practical embodiment of an information transmission apparatus for detecting, through communication, a type and state of usage of an information apparatus held by a target person and appropriately notifying the target person of information in accordance with the detected information will be described below.

As described above, as a problem of the conventional information transmission apparatus, it can output only a given kind of information regardless of the state of the target person upon detecting the presence/absence of the apparatus carried by the target person. According to an arrangement of this embodiment, the type and state of usage of an information apparatus can be detected to detect the limited appearance of the target person, and an unlimited appearance of the target person is selected, thereby effectively notifying the target person of information via the selected unlimited appearance.

(Arrangement of Information Transmission System)

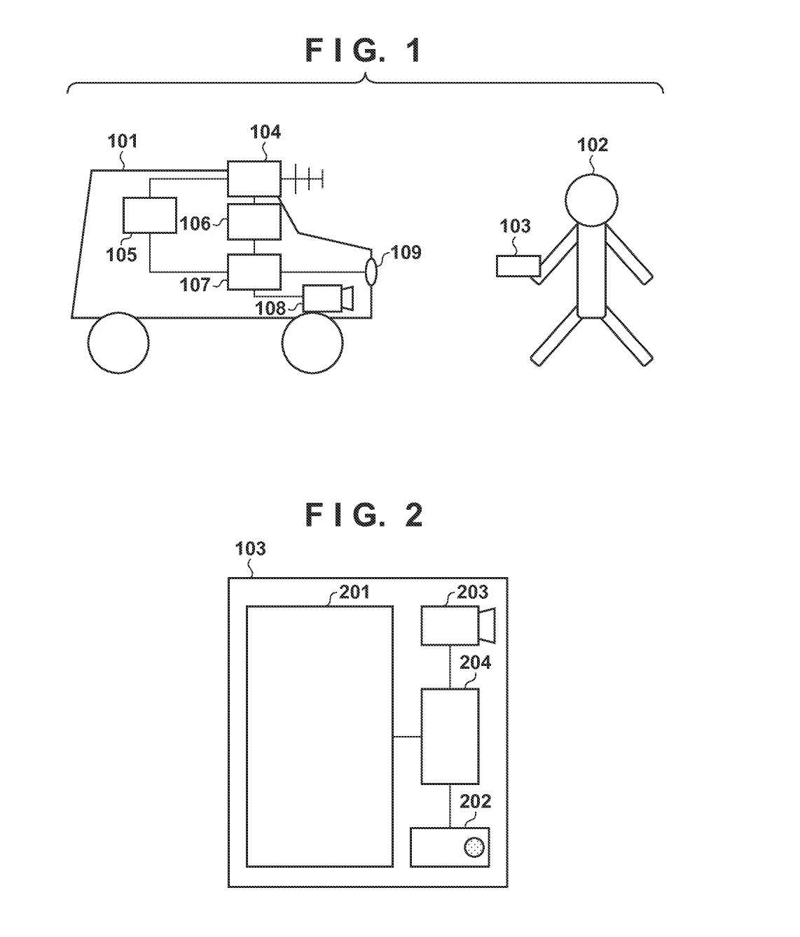

FIG. 1 is a view showing the entire arrangement of an information transmission system in which the information transmission apparatus mounted in a vehicle 101 notifies a target person 102 of information according to this embodiment.

An information terminal 103 is an information apparatus held by the target person 102. FIG. 2 is a block diagram showing the internal module arrangement of the information terminal 103. The information terminal 103 includes a touch panel screen 201 as an input/output unit. The target person can perform an input operation by a touch operation and an information output operation from the screen. The information terminal 103 also includes a voice input unit (microphone) 202 and a voice output unit (loudspeaker) 203, respectively, as the input and output units and allows the target person to perform voice communication. These input/output units allow the information terminal 103 to output input information from the target person 102 to the vehicle 101 or another external device via a wireless communication unit 204 or wirelessly receive a response from the vehicle 101 or the like and provide it to the target person 102. The information terminal 103 can be implemented by any information processing apparatus such as a smartphone, tablet terminal, or PDA communicable with an external device.

The information transmission apparatus mounted in the vehicle 101 includes an apparatus detection unit 104, a notification determination unit 105, an apparatus state detection unit 106, and a notifying unit selection unit 107. The apparatus detection unit 104 detects the presence/absence, type, and position of the information terminal 103 by wireless communication. The apparatus detection unit 104 can be implemented by an antenna to be described later and a signal processor for performing wireless communication.

The notification determination unit 105 calculates the danger of a collision between the vehicle 101 and the target person 102 and determines whether to notify the danger. The apparatus state detection unit 106 acquires the position and state of usage of the information terminal 103 via wireless communication of the apparatus detection unit 104 and detects that the appearance of the target person 102 is limited. The notifying unit selection unit 107 selects a notifying unit of the unlimited appearance, which is suitable for notification, from the limited appearance state of the target person 102 which is detected by the apparatus state detection unit 105. Some or all of the constituent components 104 to 107 of the information transmission apparatus can be implemented such that the CPU (not shown) of the information processing apparatus such as an embedded system or general-purpose personal computer performs arithmetic operations based on a predetermined computer program. Alternatively, some or all of the above constituent components may be implemented by dedicated processors, respectively.

The loudspeaker 108 is used to notify auditory information to the auditory perception of the target person 102. The loudspeaker 108 can be implemented by a horn, optionally mounted siren, loudspeaker, or the like of the vehicle 101. Headlights 109 notify information by flickering to the vision of the target person 102.

(Information Transmission Processing)

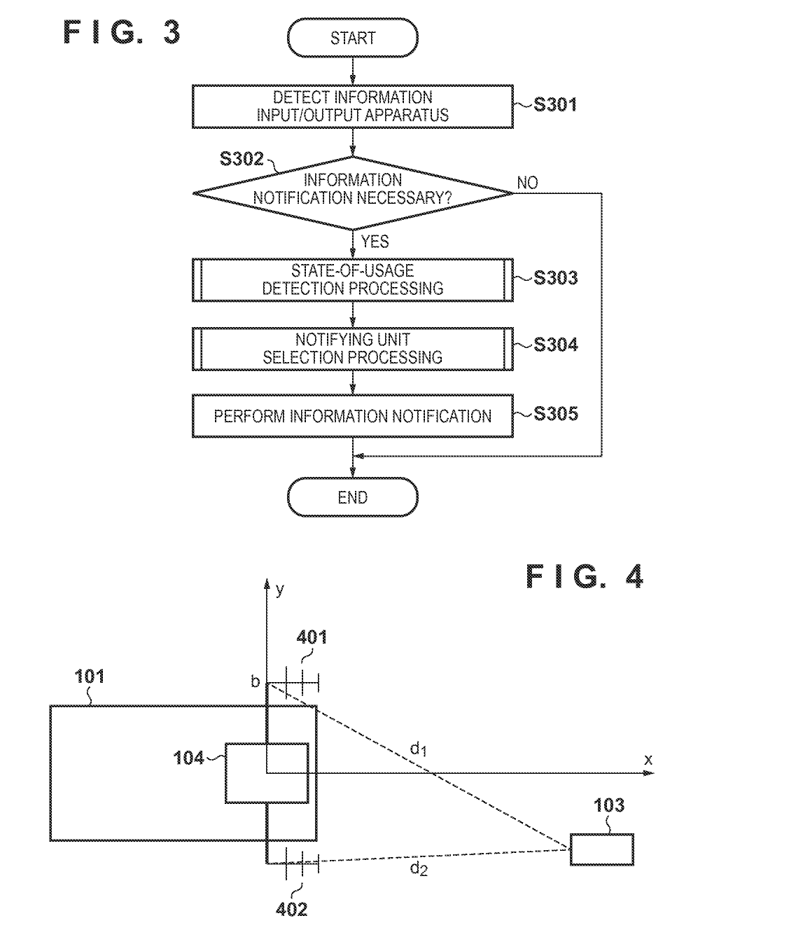

FIG. 3 is a flowchart for explaining the operations of causing the vehicle 101 traveling close to the target person 102 to notify the target person 102 of information in order to prevent a collision according to this embodiment. The steps of the flowchart are executed under the control of the CPU of the information processing apparatus mounted in the vehicle 101. The operations will be described with reference to the steps of the flowchart.

Step S301:

The apparatus detection unit 104 mounted in the vehicle 101 detects the presence/absence, type, and coarse position of the information terminal 103. FIG. 4 is a schematic view showing a state in which the vehicle 101 and the information terminal 103 are observed from the above vertically. As shown in FIG. 4, the apparatus detection unit 104 includes left and right antennas 401 and 402 for wireless communication. The antennas 401 and 402 transmit wireless inquiry signals toward the information terminal 103 and receive a response signal, thereby detecting the presence/absence and type of the information terminal 103. Distances d₁ and d₂ between the detected information terminal 103 and the left and right antennas 401 and 402 are calculated using power densities received by the respective antennas. At this time, letting (0, b) and (0, −b) be the positions of the antennas 401 and 402, respectively, when it is assumed that the information terminal 103 is positioned on the same horizontal plane as that of the vehicle 101, a position (x, y) of the information terminal 103 on the horizontal plane is defined by:

$$\{ \begin{matrix}\sqrt{{x}^{2} + {( y + b )}^{2}} = {d}_{1} \\ \sqrt{{x}^{2} + {( y - b )}^{2}} = {d}_{2}\end{matrix} \qquad ( 1 )$$

Note that, as shown in FIG. 4, on the horizontal plane in which the information terminal 103 is positioned, an x-y coordinate system is set in which the position of the apparatus detection unit 104 is defined as the origin, the forward direction of the vehicle 101 is defined as the positive direction of the x-axis, and the right-to-left direction in the forward direction of the vehicle 101 is defined as the positive direction of the y-axis. When equations (1) are solved for x and y, the position (x, y) of the information terminal 103 using the vehicle 101 as the origin can be calculated. Note that the coarse position can also be used as the coarse position of the target person 102 which holds the information terminal 103.

Step S302:

The notification determination unit 105 mounted in the vehicle 101 determines whether information notification to the target person 102 is necessary. In this embodiment, whether information notification is necessary is determined based on the presence/absence of traveling of the vehicle 101 and the distance between the vehicle and the target person 102. That is, when the vehicle 101 is traveling and the shortest distance between the vehicle 101 and the coarse position of the target person 102 calculated in step S301 is shorter than a predetermined threshold dₜₕ indicating the danger of a collision (YES in step S302), it is determined that information notification is necessary, and the process advances to step S303. If the distance is not shorter than the threshold dₜₕ (NO in step S302), it is determined that information notification is unnecessary, thereby ending the operations in this embodiment. Note that the threshold dₜₕ may be a fixed value or may change depending on the situation, as needed. For example, when the vehicle 101 is moving at a higher speed, or the target person 102 cannot directly view the vehicle 101 due to an obstacle, the threshold dₜₕ may be set to a larger value.

Step S303:

The apparatus state detection unit 106 mounted in the vehicle 101 acquires the position and state of usage of the information terminal 103 and detects the limited appearance of the target person 102. Processing (state-of-usage detection processing) of this step will be described later in detail.

Step S304:

The notifying unit selection unit 107 mounted in the vehicle 101 selects a notifying unit for performing information notification to the target person 102 based on the limited appearance of the target person 102 which is detected in step S303. Processing (notifying unit selection processing) of this step will be described later in detail.

Step S305:

By using a notifying unit such as the loudspeaker 108 or headlights 109 mounted in the vehicle 101, which is selected in step S304, information notification is performed to the target person 102. The information notification is performed such that the driver sounds the horn via the loudspeaker 108 or continuously or automatically flickers the headlights 109 so as to allow the target person 102 to readily perceive the danger.

(State-of-Usage Detection Processing)

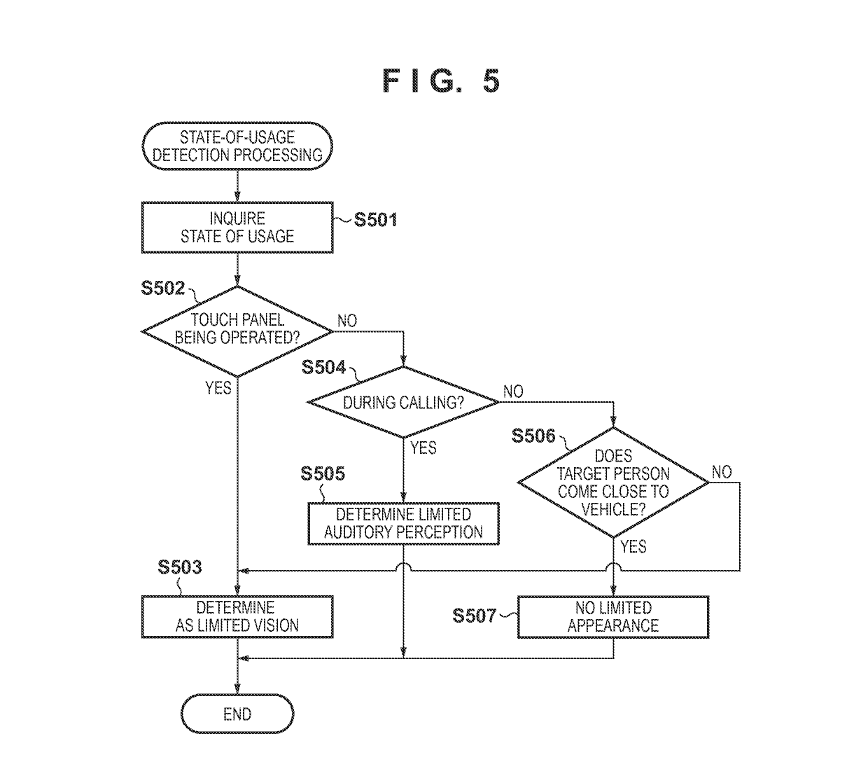

The state-of-usage detection processing to be executed in step S303 described above will now be described in detail. FIG. 5 is a flowchart for explaining the operations of the state-of-usage detection processing. As described above, in the state-of-usage detection processing, the limited appearance of the target person is detected. The operations will be described below in accordance with the steps of the flowchart.

Step S501:

An inquiry is made to the information terminal 103 using the antennas 401 and 402 of the apparatus detection unit 104 to acquire the state of usage of the information terminal 103.

Step S502:

It is determined based on the state of usage of the information terminal 103 whether the target person 102 is operating the touch panel 201. If it is determined that target person 102 is operating the touch panel 201 (YES in step S502), the process advances to step S503 because it is estimated that the target person 102 is operating the touch panel 201 while gazing the screen. If it is determined the target person 102 is not operating the touch panel 201 (NO in step S502), the process advances to step S504.

Step S503:

It is determined that the vision of the target person 102 is limited, the state-of-usage detection processing ends.

Step S504:

It is determined whether the target person 102 is calling (voice communication) from the state of usage of the information terminal 103. If it is determined that the target person 102 is calling (YES in step S504), the process advances to step S505 because it is estimated that the target person 102 concentrates in conversation with a partner. If it is determined that the target person 102 is not calling (NO in step S504), the process advances to step S506.

Step S505:

It is determined that the auditory perception of the target person 102 is limited, and the state-of-usage detection processing ends.

Step S506:

The moving direction of the target person 102 with respect to the vehicle 101 is determined from a change in position of the information terminal 103. When the target person 102 is moving in a direction to come close to the vehicle 101, except the movement of the vehicle 101 (YES in step S506), it is estimated that the target person 102 faces the direction of the vehicle 101 and can view the vehicle 101. The process then advances to step S507. If it is determined that the movement is not in a direction to come close to the vehicle 101 (NO in step S506), the process advances to step S503 because it is estimated that the target person 102 cannot view the vehicle 101.

Step S507:

It is determined that the appearance of the target person 102 is not specifically limited, and the state-of-usage detection processing ends.

By the above operations, the limited appearance of the target person 102 is detected in step S303.

(Notifying Unit Selection Processing)

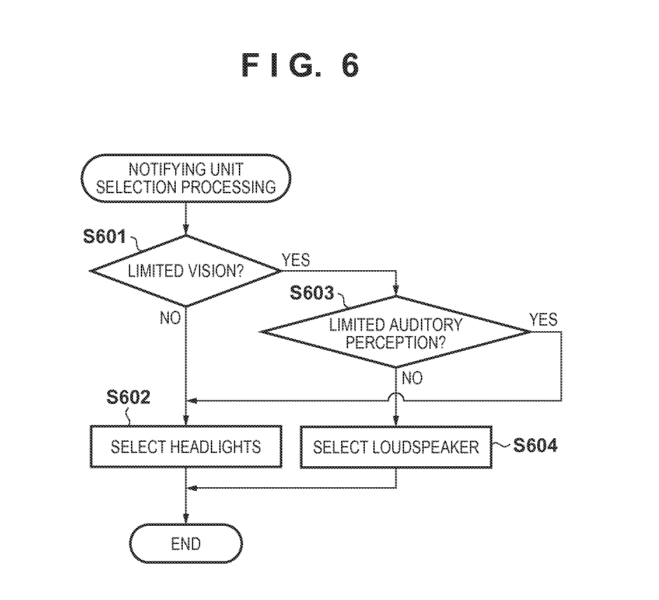

The notifying unit selection processing executed in step S304 described above will be described below in detail. FIG. 6 is a flowchart for explaining the operations of the notifying unit selection processing. As described above, in the notifying unit selection processing, a notifying unit for notifying information through an unlimited appearance of the target person is selected in accordance with the detection result of the state-of-usage detection processing. The operations will be described in accordance with the steps of the flowchart.

Step S601:

It is determined whether the limited appearance of the target person 102 which is detected in step S303 is the limitation of vision. If it is determined that the vision is limited (YES in step S601), the process advances to step S603; otherwise (NO in step S601), the process advances to step S602.

Step S602:

The headlights 109 which can be perceived by the target person 102 and notify information notification through vision are selected as a notifying unit, and the notifying unit selection processing ends.

Step S603:

It is determined whether the limited appearance of the target person 102 which is detected in step S303 is the limitation of auditory perception. If it is determined that the auditory perception is limited (YES in step S603), the process advances to step S602; otherwise (NO in step S603), the process advances to step S604.

Step S604:

The loudspeaker 108 which can be perceived by the target person 102 and notifies information notification through auditory perception is selected as a notifying unit, and the notifying unit selection processing ends.

By the above operations, an appropriate notifying unit for the target person 102 can be selected in step S304.

As described above, according to the arrangement of this embodiment, the type, state of usage, and the like of the information terminal are detected to detect the limited appearance of the target person and select an unlimited appearance, thereby performing information notification. Even if the appearances such as vision and auditory perception are limited such that the target person concentrates in screen operation of the information terminal and conversation with a partner, an appropriate notifying unit which can be readily perceived by the target person is used to reliably perform information notification such as a warning indicating that the vehicle comes close to the target person.

In addition to the above embodiment, a practical embodiment of an information transmission apparatus for notifying a target person of information via an output interface of an information apparatus held by the target person, if possible, will be described below.

In the embodiment described above, the limited appearance of the target person is detected from the state of usage of the information apparatus, and the output interface of the information transmission apparatus mounted in the vehicle 101 is selected, thereby performing information notification. To the contrary, according to this embodiment, if possible, notification is performed via an output interface such as a screen, loudspeaker, or vibration motor of the information apparatus used by the target person. This makes it possible to perform appropriate and reliable information notification.

The entire arrangement of an information transmission apparatus for notifying a target person 102 of information from a vehicle 101 is the same as that of the first embodiment described with reference to FIG. 1. Note that an information terminal 103 has a function as an information notifying unit for performing information notification to the target person 102 in addition to the functions of the information apparatus of the first embodiment.

A flowchart for explaining the operations of this embodiment is the same as in FIG. 3 of the first embodiment. Note that notifying unit selection processing in step S304 and information notification in step S305 are different from those of the first embodiment. The operations of steps S304 and S305 of this embodiment will be described below.

(Notifying Unit Selection Processing)

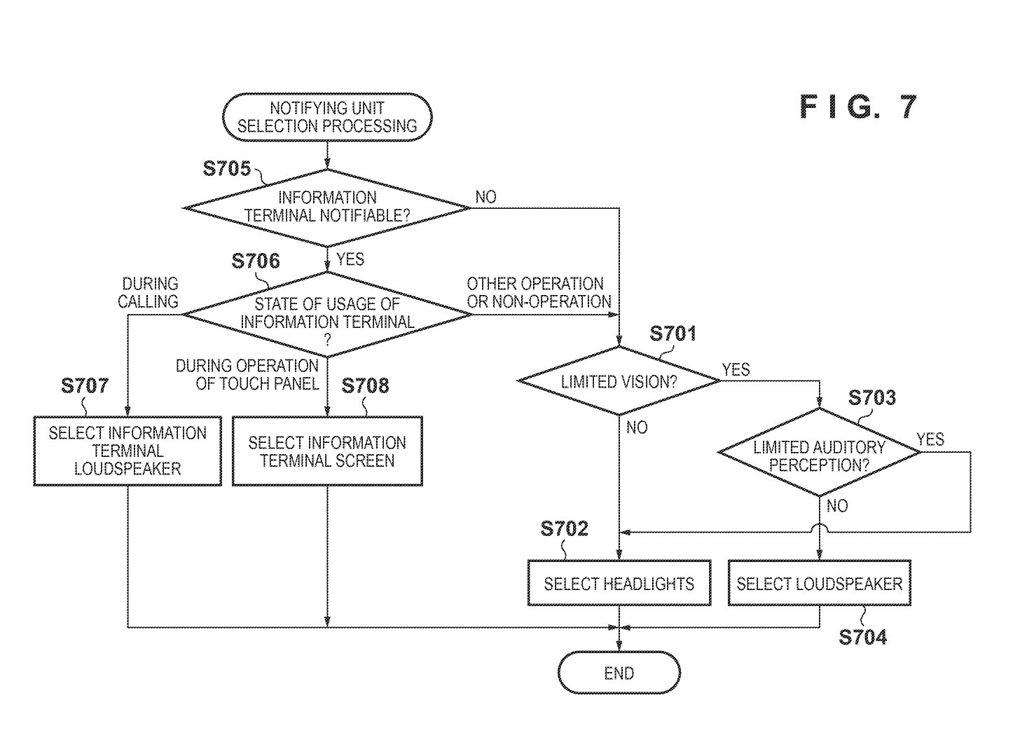

FIG. 7 is a flowchart showing the processing sequence of notifying unit selection processing in this embodiment. The operations will be described in accordance with the steps of the flowchart.

Steps S701 to S704:

The same operations as in steps S601 to S604 of FIG. 6 of the first embodiment are performed.

Step S705:

An inquiry is made to the information terminal 103 using antennas 401 and 402 of an apparatus detection unit 104 to determine whether information notification via the information terminal 103 is possible. The information terminal 103 sends back a response indicating whether notification is possible, in consideration of the presence/absence of such an information notification function and priorities of the security setting by a maker or user serving as the target person 102 and currently processed contents. If it is determined that the notification is possible (YES in step S705), the process advances to step S706. If it is determined that the notification is impossible (NO in step S705), the process returns to step S701.

Step S706:

An inquiry is made to the information terminal 103 using the antennas 401 and 402 of the apparatus detection unit 104 to acquire the state of usage of the information terminal 103. In this embodiment, the information notifying unit used in accordance with the state of usage is changed. During calling of the information terminal 103, the process advances to step S707. During the operation of the touch panel, the process advances to step S708. During another operation state or in a non-operation state, the process returns to step S701.

Step S707:

The loudspeaker of the information terminal 103 which is currently used for calling by the target person 102 is selected as the notifying unit, and the operation of the notifying unit selection processing ends.

Step S708:

The screen of the information terminal 103 on which the target person 102 is currently operating while gazing is selected as the notifying unit, and the operation of the notifying unit selection processing ends.

As described above, the output interface of the information apparatus as the notifying unit for notifying the target person of information is selected in accordance with the state of usage of the information apparatus. This makes it possible to select an appropriate notifying unit to the target person 102 in consideration of the information notification via the information terminal 103.

(Information Notification)

Step S305:

Information notification to the target person 102 is performed using one of the loudspeaker 108 mounted in the vehicle 101, the headlights 109 mounted in the vehicle 101, the screen of the information terminal 103, and the loudspeaker of the information terminal 103, which is selected in step S304. When the loudspeaker 108 or headlights 109 of the vehicle 101 are used, the information notification is performed by sounding the horn via the loudspeaker 108 or continuously or automatically flickering the headlights 109 so as to allow the target person 102 to readily perceive the danger. When the output interface of the information terminal 103 is used, an attention must be taken not to the information terminal 103 but to the vehicle 101. For this reason, a detailed message such as “the vehicle comes close to you from the left. Be careful” or an icon is emphasized and displayed on the screen. Alternatively, such a message is output as a voice message via the loudspeaker.

The information transmission apparatus of this embodiment detects the limited appearance of the target person upon detecting the type and state of usage of the information terminal and selects an unlimited appearance. In addition, the information transmission apparatus performs information notification via the information terminal, if possible. Even if the target person concentrates in screen operations of the information terminal or conversation with a partner, warning information indicating that the vehicle comes close to the target person can be reliably notified using an appropriate notifying unit which is readily perceived by the target person.

The information apparatus of this embodiment can determine the state of usage of the information apparatus in response to a request from the information transmission apparatus and transmit the state of usage of the information apparatus to the information transmission apparatus. The information transmission apparatus can notify the target person of information using the notifying unit corresponding to the state of usage of the information apparatus. For this reason, the information apparatus cooperates with the information transmission apparatus to appropriately and reliably notify the target person of the information.

A practical embodiment of an information transmission apparatus for notifying a target person of information by a combination of a plurality of notifying units will be described below.

The above embodiments have described a case in which one notifying unit is decided based on the detected limited appearance of the target person, and information notification is performed using one notifying unit. To the contrary, this embodiment selects a plurality of notifying units based on the various kinds of limited appearances in various kinds of states of usage of the information terminal, thereby appropriately and reliably allowing information notification.

The entire arrangement of the information transmission apparatus for notifying a target person 102 of information from a vehicle 101 is the same as in the above embodiments, as shown in FIG. 1. Note that an information terminal 103 also has a function as an information notifying unit for performing information notification to the target person 102 as in the above embodiments. In addition, by driving a vibration motor, the information terminal 103 also has an information notification function using vibrations.

A flowchart for explaining the operations of this embodiment is the same as in FIG. 3 of the previous embodiments. Note that state-of-usage detection processing in step S303, the notifying unit selection processing in step S304, and the information notification processing contents in step S305 are different from those of the previous embodiment. The operations of steps S303, S304, and S305 of this embodiment will be described below.

Step S303 (State-of-Usage Detection Processing):

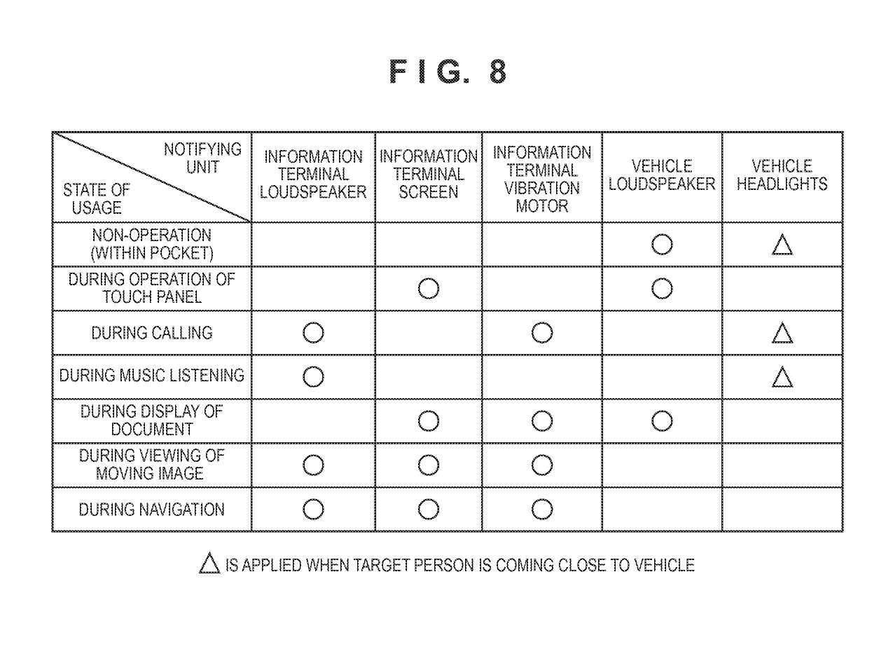

An apparatus state detection unit 106 mounted in the vehicle 101 acquires the position and state of usage of the information terminal 103 to detect the limited appearance of the target person 102. As shown in the items of the states of usage in FIG. 8, the detailed states of usage of the information terminal 103 are acquired to express the limited appearance states not for each appearance but for each state of usage.

FIG. 8 is a table showing the correspondence relationship between the states of usage of the information terminal 103 and usable notifying units. Referring to FIG. 8, the detectable states of usage are exemplified as “non-operation (within a pocket)”, “during operation of touch panel”, “during calling”, “during music listening”, “during document display”, “during viewing of moving image”, and “during navigation”. The usable notifying units are exemplified as “information terminal loudspeaker”, “information terminal screen”, “information terminal vibration motor”, “vehicle loudspeaker”, and “vehicle headlights”. For example, when the state of usage of the information terminal 103 is “during operation of touch panel”, it is estimated that the target person 102 concentrates in a touch panel screen 201. As the notifying units, the touch panel screen 201 (“information terminal screen”) and the loudspeaker 108 (“vehicle loudspeaker”) using auditory perception whose appearance is not limited are selected as use target candidates in FIG. 8. “◯” and “Δ” in the table of FIG. 8 indicate usable notifying units in accordance with the detection of the states of usage. In particular, “Δ” is the notifying unit usable when the target person 102 is moving in a direction where the vehicle 101 exists. When the target person 102 is moving toward the direction of the vehicle 101, it is estimated that the target person 102 can recognize the vision information from the vehicle 101 as long as the target person 102 does not perform a job by which vision is limited. For this reason, in FIG. 8, when the information terminal is set in the state of usage of “non-operation (within a pocket)”, “during calling”, and “during music listening” by which the vision is not limited, the “vehicle headlights” for information notification using vision are used when the target person 102 comes close to the vehicle 101.

Step S304 (Notifying Unit Selection Processing)

Based on the limited appearance of the target person 102 which is detected in step S303, the notifying unit selection unit 107 mounted in the vehicle 101 selects a notifying unit for performing information notification to the target person 102. As shown in FIG. 8, one or more notifying units are selected in correspondence with the state of usage of the information terminal 103 which is obtained in step S303. Note that the headlights 109 of the vehicle 101 are applied only when the target person 102 is moving close to the vehicle 101 as in step S506 of the above embodiment.

When the state of usage of the information terminal 103 is acquired, the target of interest attracted by the target person 102 to some extent and the appearance limiting state corresponding to the target of interest can be estimated. However, for example, in a state in which a document is being displayed, the target person 102 does not always gaze at the screen. For this reason, display of the information notification on the screen is insufficient depending on the situation. The attention of the target person 102 is attracted to the screen by vibrating the information terminal 103 using the vibration motor and at the same time by the notification using the loudspeaker 108 of the vehicle 101 in a case that the notification is insufficient by only the vibrations. As described above, the combination of effective notifying units allows more reliable information notification.

Step S305 (Information Notification):

The information notification is performed to the target person 102 using a combination of the loudspeaker 108 mounted in the vehicle 101, the headlights 109 mounted in the vehicle 101, the screen of the information terminal 103, the loudspeaker of the information terminal 103, the vibration motor of the information terminal, and the like, which are selected in step S304. When the loudspeaker 108 or headlights 109 of the vehicle 101 are used, the information notification is performed by sounding the horn via the loudspeaker 108 or continuously or automatically flickering the headlights 109 so as to allow the target person 102 to readily perceive the danger. When the screen or loudspeaker of the information terminal 103 is used, an attention must be taken not to the information terminal 103 but to the vehicle 101. For this reason, a detailed message such as “the vehicle comes close to you from the left. Be careful” or an icon is emphasized and displayed on the screen. Alternatively, such a message is output as a voice message via the loudspeaker. The vibration motor of the information terminal 103 vibrates so as to cause the target person 102 to hold the information terminal 103 or cause the target person 102 to pay attention to the information terminal 103.

The various kinds of information notifying units does not perform uniform operations at the time of notification. The notification order and contents of these kinds of information notifying units are appropriately controlled to perform optimal information notification by the state of usage and a combination of the notifying units. For example, when information is notified during display of a document at the information terminal 103, the vibration motor of the information terminal 103 is driven to attract the attention of the target person 102 toward the information terminal 103 and perform on the screen the notification indicating that the vehicle comes close to the target person. Finally, the notification can be performed by a voice message through the loudspeaker 108 of the vehicle 101. By controlling the notifying method as described above, it is possible to naturally notify the target person 102 of information indicating that the vehicle 101 comes close without confusing the target person 102.

According to this embodiment, the correspondence relationship between the states of usage of the target person and the usable notifying units is defined in advance. A notifying unit corresponding to the state of usage of the target person is selected using the correspondence relationship. For this reason, reliable information notification can be performed using a more appropriate notification unit corresponding to the state of usage of the target person. In addition, according to this embodiment, a plurality of notifying units are appropriately selected in accordance with the state of usage of the target person to implement more effective information transmission. For example, even if the limited appearance of the target person is difficult to uniformly assume and the notification is difficult using a single notifying unit, reliable information notification can be performed by an appropriate combination of the plurality of notifying units.

In the above embodiments, in the system in which the target person 102 holds the information terminal 103, the example of the arrangement for automatically selecting the notifying unit and perform information notification has been described. In the following description, in a system in which a target person does not hold an information terminal, a practical embodiment will be described in which the limited appearance state of the target person is automatically detected and the information notification is performed using an appropriate notifying unit to the target person.

The conventional information transmission apparatus has a problem in which only a uniform kind of information is output regardless of the state of the target person. According to this embodiment, the limited appearance of the target person can be detected, and the unlimited appearance can be selected to perform the information notification.

(Arrangement of Information Transmission System)

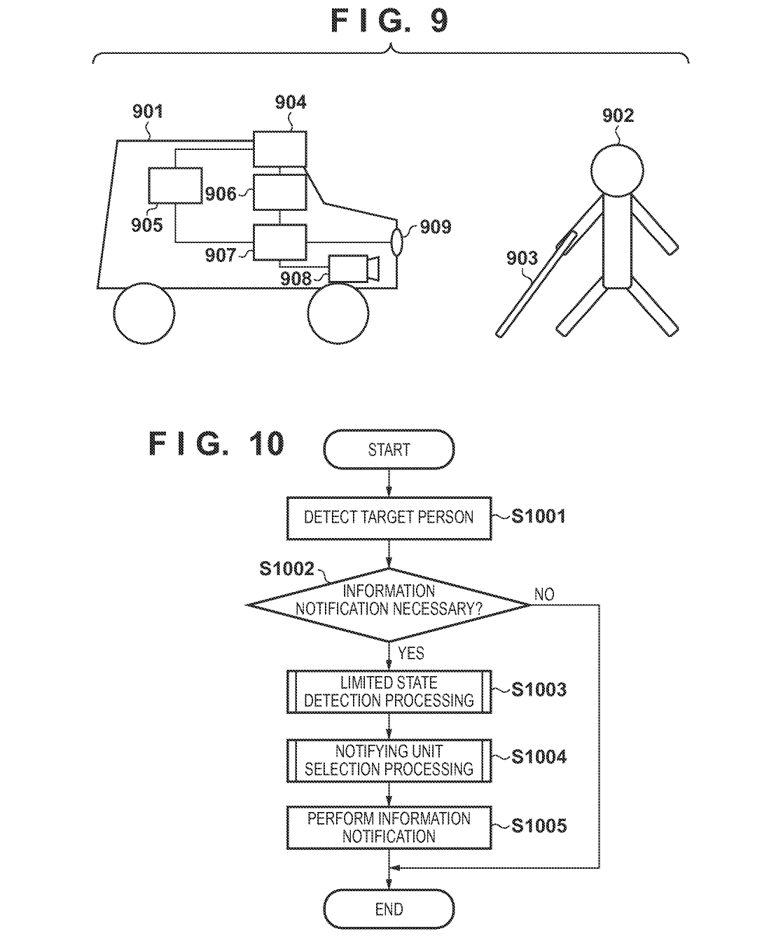

FIG. 9 is a view showing the entire arrangement of an information transmission system in which the information transmission apparatus mounted in a vehicle 901 notifies a target person 902 as a visually handicapped person of information according to this embodiment.

A white cane 903 is an auxiliary tool for a visually handicapped person, which is held by the target person 902. The person who holds the white cane can be recognized as the visually handicapped person by determining the presence/absence of the white cane from the outer appearance.

The information transmission apparatus mounted in the vehicle 901 includes a person detection unit 904, a notification determination unit 905, a limited appearance detection unit 906, and a notifying unit selection unit 907. The person detection unit 904 detects the presence/absence and position of the target person 902 from a captured image obtained from the internal camera. The notification determination unit 905 calculates the danger of a collision between the vehicle 901 and the target person 902 and determines whether the notification is necessary. The limited appearance detection unit 906 analyzes the captured image obtained via the image capturing device of the person detection unit 904 and detects that the appearance of the target person 902 is limited. The notifying unit selection unit 907 selects a notifying unit corresponding to the unlimited appearance suitable for notification from the limited appearance state of the target person 902 which is detected by the limited appearance detection unit 906. Some or all of the constituent components 904 to 907 of the vehicle 901 can be implemented by the CPU (not shown) of the information processing apparatus which can perform arithmetic operations based on a predetermined computer program as in the previous embodiment. Alternatively, some or all of the above constituent components may be implemented by dedicated processors, respectively.

A loudspeaker 908 notifies the target person 902 of auditory information in order to notify information to the auditory perception of the target person 902. The loudspeaker 908 can be implemented by a horn, optionally mounted siren, loudspeaker, or the like of the vehicle 901. Headlights 909 notify information by flickering to the vision of the target person 902.

(Information Transmission Processing)

FIG. 10 is a flowchart for explaining the operations of causing the vehicle 901 traveling close to the target person 902 to notify the target person 902 of information in order to prevent a collision. The steps of the flowchart are executed under the control of the CPU of the information processing apparatus mounted in the vehicle 901. The operations will be described with reference to the steps of the flowchart.

Step S1001:

The person detection unit 904 mounted in the vehicle 901 detects the presence/absence and coarse position of the target person 902. FIG. 11 is a schematic view showing a state in which the vehicle 901 and the target person 902 are observed from the above vertically. As shown in FIG. 11, the person detection unit 904 includes left and right cameras 1101 and 1102 for image capturing. The cameras 1101 and 1102 capture images of the front side of the vehicle 901 and detect the presence/absence of the target person 902 to be notified of the information from these captured images. The detection of the target person 902 is performed by detecting the position of the person in the captured image. This position is detected by extracting a feature from an image using a generally used HOG feature amount and performing image recognition having undergone weighted learning using Boosting. HOG stands for Histograms of Oriented Gradients.

The position of the target person 902 is then obtained from the positions of the images, of the detected target person 902, obtained by the cameras 1101 and 1102. More specifically, the position of the target person 902 is calculated based on relative angles θ₁ and θ₂ between the target person 902 and the front directions of the cameras 1101 and 1102 on the horizontal plane and the positions of the cameras 1101 and 1102. Letting (0, b) be the position of the camera 1101 and (0, −b) be the position of the camera 1102 and assuming that the target person 902 is positioned on the same horizontal plane as that of the vehicle 101, a position (xₜ, yₜ) of the target person 902 is given by:

$$\{ \begin{matrix}{x}_{t} = \frac{2 b}{tan {θ}_{2} - tan {θ}_{1}} \\ {y}_{t} = \frac{2 b tan {θ}_{2}}{tan {θ}_{2} - tan {θ}_{1}} - b\end{matrix} \qquad ( 2 )$$

Note that, as shown in FIG. 11, on the horizontal plane in which the target person 902 is positioned an x-y coordinate system is set in which the position of the person detection unit 904 is defined as the origin, the forward direction of the vehicle 901 is defined as the positive direction of the x-axis, and the right-to-left direction in the forward direction of the vehicle 901 is defined as the positive direction of the y-axis. By solving equations (2) for xₜ and yₜ, the position (xₜ, yₜ) of the target person 902 having the vehicle 901 as the origin can be obtained.

Step S1002:

The notification determination unit 905 mounted in the vehicle 901 determines whether information notification to the target person 902 is necessary. When the vehicle 901 is traveling and the shortest distance between the vehicle 901 and the position of target person 902 on the horizontal plane calculated in step S901 is shorter than a predetermined threshold dₜₕ indicating the danger of a collision (YES in step S1002), it is determined that information notification is necessary, and the process advances to step S1003. If the distance is not shorter than the threshold dₜₕ (NO in step S1002), it is determined that information notification is unnecessary, thereby ending the operations in this embodiment. Note that the threshold dₜₕ may be a fixed value or change depending on the situation, as needed, as in the previous embodiment.

Step S1003:

The limited appearance detection unit 906 mounted in the vehicle 901 detects the limited appearance state of the target person 902. The processing (limited state detection processing) of this step will be described below in detail.

Step S1004:

The notifying unit selection unit 907 mounted in the vehicle 901 selects a notifying unit for performing information notification to the target person 902 based on the limited appearance of the target person 901 which is detected in step S1003. The processing contents of this step are the same as the notifying unit selection processing performed in step S304 in FIG. 3 of the previous embodiment, and the details of this processing is shown in FIG. 6.

Step S1005:

The information notification is performed for the target person 902 using the loudspeaker 908 or headlights 909 mounted in the vehicle 901 which are selected in step S1004. The information notification is performed such that the driver sounds the horn via the loudspeaker 908 or continuously or automatically flickers the headlights 909 so as to allow the target person 902 to readily perceive the danger.

(Limited Appearance State Detection Processing)

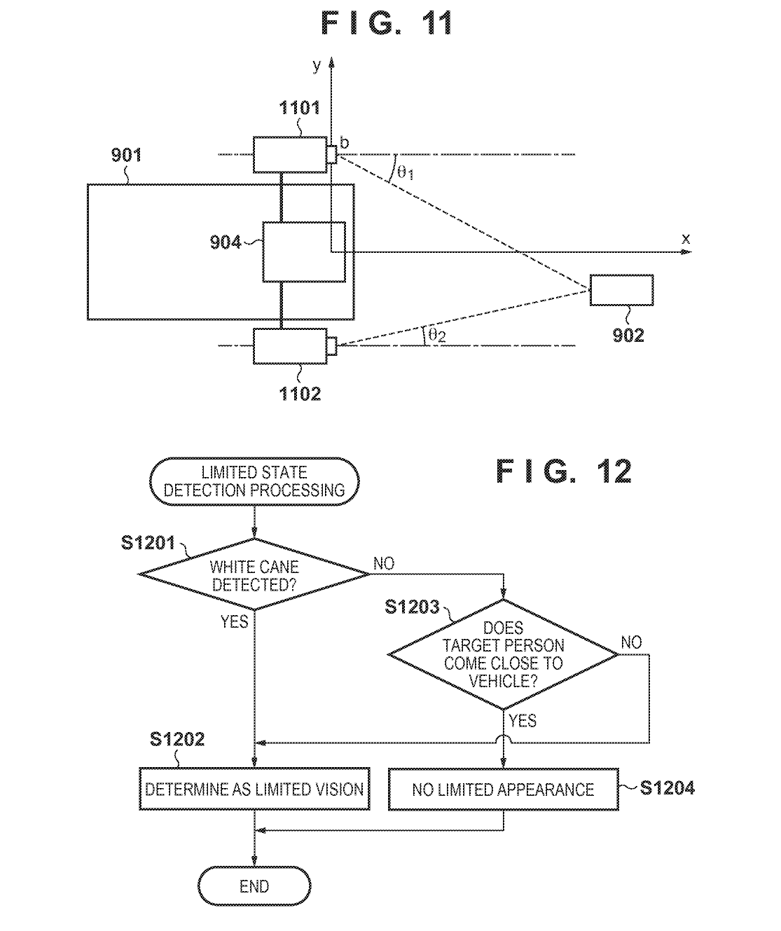

The limited state detection processing executed in step S1003 described above will be described below in detail. FIG. 12 is a flowchart for explaining the operation of the limited state detection processing. The operations will be described in accordance with the steps of the flowchart.

Step S1201:

In step S1201, the captured image of the target person is analyzed to detect the limited appearance of the target person. In this embodiment, a belonging held or carried by the target person 902 is detected using the cameras 1101 and 1102 of the person detection unit 904. A specific white region constituting the white cane 903 is extracted within the limited person region detected in step S1001. If a ratio r of the number p_{w} of pixels of the extracted specific white region to the number pₕ of pixels of the person region is a threshold ratio rₜₕ or more, it is determined that the white cane is detected. The flow advances to step S1202. If the ratio rₑ is lower than the threshold ratio rₜₕ, the flow advances to step S1203.

Step S1202:

It is determined that the vision of the target person 902 is limited, and the limited state detection processing ends.

Step S1203:

The moving direction of the target person 902 with respect to the vehicle 901 is determined from the change in position of the target person 902. When it is determined that the target person 902 is moving in a direction to come close to the vehicle 901, except the movement of the vehicle 901 (YES in step S1203), it is determined that the target person 902 faces the vehicle 901 and can view the vehicle 901, and the process advances to step S1204. If it is determined that the target person 902 moves away from the vehicle 901 (NO in step S1203), it is determined that the target person 902 cannot view the vehicle 902. The process advances to step S1202.

Step S1204:

It is determined that the appearance of the target person 902 is not specifically limited, and the limited state detection processing ends.

By the above operations, the limited appearance of the target person 902 can be detected in step S1003.

As described above, according to this embodiment, the captured image of the target person is analyzed to detect the limited appearance of the target person. The unlimited appearance is selected to perform the information notification. Even if the target person is a visually handicapped person and the information notification by vision is not effective, the auditory perception given by an appropriate notifying unit which allows perception of the target person is used to appropriately notify the target person of the warning information indicating that the vehicle comes close to the target person.

Still another embodiment will be described below.

In the embodiments described above, an example has been described in which the information terminal 103 having the output interface such as the screen, loudspeaker, or vibration motor is used as the information apparatus held by the target person. The present invention is not limited to this. Various kinds of apparatuses which can be operated by the target person and can notify the target person of information can be used. For example, a music reproduction apparatus (portable music player) for allowing the target person to listen to music may be used. Alternatively, a head-mounted display information terminal which is mounted on a head in place of the hand-held form and directly presents an image in the visual field of the target person may be used. The information apparatus may be implemented by a wearable terminal such as a wrist watch type terminal or eye glass type terminal. In addition, the information apparatus may be a navigation system which is operated when the target person gets in the vehicle. As described above, suitable apparatuses are used depending on various kinds of situations, and the information notification can be performed under various conditions.

The apparatus detection unit 104, the notification determination unit 105, and the apparatus state detection unit 106 in the above embodiments perform wireless communication with the information terminal 103 to acquire the presence/absence, type, position, and state of usage of the information terminal 103. However, the present invention is not limited to this. For example, the presence/absence, type, position and state of usage of the information terminal 103 may be acquired by image recognition using the cameras 1101 and 1102 shown in FIG. 11 in place of the antenna 401 and 402 shown in FIG. 4 of the previous embodiment. In this case, the person is recognized from an image at the front side of the vehicle, which is obtained from the image capturing device, and an apparatus added to the person image is detected. For example, if an apparatus is attached to the ear portion, it is possible to detect that an earphone is attached to the ear portion and the target person is listening to music. If the target person holds something in his hand and faces his face toward this, it is possible to detect that the target person is using the information terminal 103. In this manner, image recognition is performed in place of wireless communication, and wireless communication between the vehicle 101 and the information terminal 103 is unnecessary, thereby simplifying the apparatus. Of course, it is possible to perform more reliable information notification by combining wireless communication and image recognition. For example, the information terminal 103 may incorporate a GPS (Global Positioning System) receiver and position information detected by the GPS may be transmitted from the information terminal 103 to the information transmission apparatus.

The limited appearance detection unit 906 according to the previous embodiment recognizes the image of the white cane held by the target person 902 using the captured images from the cameras 1101 and 1102. The present invention, however, is not limited to this. In place of the white cane, another clue, for example, a guide dog for blind, for detecting that the target person is one of various types of handicapped persons may be detected.

A hearing aid representing an auditory handicapped person is very small and difficult to detect by only an image. However, a reflecting material for reflecting a specific wavelength is attached to the target person 902, and an image may be captured using a light source having the same specific wavelength reflected by the reflecting material. This makes it possible to extract the region of the specific wavelength in the recognized target person 902, thereby detecting that the target person is the auditory handicapped person. However, a detection method using a combination of the wireless communication and image recognition may be used in place of the image recognition, as a matter of fact.

The notification determination unit 105 of the embodiment described above calculates the danger of a collision between the vehicle 101 and the target person 102 and determines whether notification is necessary. However, the present invention is not limited to this. For example, the above-described technique may be applied to an advertisement apparatus for outputting an image or sound in place of the vehicle 101. The advertisement apparatus determines the state of an advertisement target from its sex and age in a state in which the target person 102 is in a close contact state. The advertisement apparatus selects an appropriate notifying unit and performs the information notification as an advertisement. This makes it possible to notify, by an effective unit, an advertisement which makes an appropriate target person be conscious of the advertisement.

In addition, the present invention may be applied to a camera which shoots a target person as an object. An appropriate notifying unit is selected so that the target person faces the camera, and information notification is performed, thereby performing photographic shooting with a good composition.

The present invention is also applicable to not only the camera aiming at photographic shooting, but also a security camera installed downtown. When a danger such as a robber or stalker is imminent for the target person, an appropriate notifying unit for invoking the warning to the target person is selected to perform the information notification, thereby improving the effect as the security camera.

Furthermore, for example, neighboring persons can call a waiting partner using a portable telephone. More specifically, assume that a calling person who notifies information calls a target person. When the calling person calls the target person with his portable telephone, the notifying unit suitable for the target person is selected. The notification is performed using a notifying unit suitable for the calling person using at least one of the screen, loudspeaker, vibration motor, or the like of the portable telephone of the calling or target person. This makes it possible to reliably and quickly call the target person.

The information notifying unit in the previous embodiments has performed information notification via vision, auditory perception, and tactile perception as of the loudspeaker 108 and the headlights 109, and the screen, loudspeaker, and vibration motor of the information terminal 103. The present invention is not limited to this. For example, air having a predetermined scent such as an irritant odor may be emitted toward the nasal cavity of the target person 102 using a swingable air gun, thereby performing information notification using scent (olfactory perception). Even in a situation in which the target person is notified of information indicating the danger of, for example, toxic gas leakage, the target person can directly smell the gas, thereby knowing the danger.

The notifying unit selection unit in the above embodiments selects a notifying unit corresponding to the unlimited appearance suitable for notification. The notifying unit selection unit may select not only the notifying unit selected under the specific condition but also all possible notifying units. For example, when information notification is performed for target persons against very urgent dangers which jeopardise the life and property or for an infinite number of target persons for the same reason, the notifying unit selection unit performs information transmission using all the notifying units connected to the information transmission apparatus in accordance with the degree of urgency. Light flickering and sound generation are simultaneously performed to effectively and reliably inform the target person of the danger although such the notification may bother surrounding people.

The present invention can provide a technique for appropriately and reliably transmitting information even if the appearance of the target person is limited.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-254495, filed Dec. 9, 2013, which is hereby incorporated by reference herein in its entirety.

What is claimed is:

1. An apparatus for informing a target person of information, comprising:
a detection unit adapted to detect a limited appearance of the target person based on a state of usage of another apparatus of the target person;
a selection unit adapted to select a notifying unit for notifying the target person of information through an unlimited appearance of the target person based on the detection result of said detection unit; and
a control unit adapted to control to notify the target person of information by the notifying unit selected by said selection unit.

2. The apparatus according to claim 1, further comprising an acquisition unit adapted to acquire a state of usage of an information apparatus held by the target person.

3. The apparatus according to claim 2, wherein when the information apparatus is operated, said detection unit detects a limited vision of the target person.

4. The apparatus according to claim 2, wherein when the information apparatus output a voice, said detection unit detects that auditory perception of the target person is limited.

5. The apparatus according to claim 2, wherein said detection unit detects based on a moving direction of the target person whether vision of the target period is limited.

6. The apparatus according to claim 2, wherein when it is detected that vision of the target person is limited, said selection unit selects a loudspeaker as the notifying unit.

7. The apparatus according to claim 2, wherein when it is detected that auditory perception of the target person is limited, said selecting unit selects a light as the notifying unit.

8. The apparatus according to claim 2, wherein
said selection unit selects, as the notifying unit, an output interface of the information apparatus in accordance with a state of usage of the information apparatus, and
when the output interface of the information apparatus is selected as the notifying unit, said control unit notifies the information apparatus of information from the output interface.

9. The apparatus according to claim 1, wherein said detection unit analyzes a captured image of the target person and detects the limited appearance of the target person.

10. The apparatus according to claim 1, wherein said selection unit selects a plurality of notifying units in accordance with detection result of said detection unit.

11. The apparatus according to claim 1, wherein the notifying unit notifies information through at least one of vision, auditory perception, tactile perception, and olfactory perception.

12. A method of controlling an apparatus for notifying a target person of information, comprising:
a detection step of causing a detection unit to detect a limited appearance of the target person based on a state of usage of another apparatus of the target person;
a selection step of causing a selection unit to select a notifying unit for notifying the target person of information through an unlimited appearance based on the detection result of the detection step; and
a control step of causing a control unit to control to notify the target person of information by the notifying unit selected in the selection step.

13. A non-transitory computer-readable storage medium storing a computer program for causing a computer to function as each unit of an apparatus of claim 1.
